(19) United States
(12) Patent Application Publication
(10) Pub. No.: US 2005/0130785 A1
(43) Pub. Date: Jun. 16, 2005

(54) Bevel gear

(75) Inventor: Masahiro Konda, Toyohashi-Shi (JP)

Correspondence Address: Ladas & Parry, 26 West 61 Street, New York, NY, 10023, US

(73) Assignee: MUSASHI SEIMITSU KOGYO KABUSHIKI KAISHA

(21) Appl. No.: 10/965,002

(22) Filed: Oct. 14, 2004

(30) Foreign Application Priority Data
Oct. 15, 2003 (JP) 2003-355640

(51) Int. Cl. F16H 48/06

(52) U.S. Cl. 475/230

(57) ABSTRACT

The present invention is a bevel gear having a plurality of teeth (12) on an outside periphery thereof, each of both tooth flanks (13, 13) of each of the plurality of teeth (12) forming a crowning way with a bulge in a tooth trace direction, a generating line (P) of a standard pitch cone of each of the plurality of teeth (12) inclining with respect to an axial center (X, Y), wherein each of the tooth flanks (13) of the plurality of teeth (12) is formed into an arch shape, at least at a central portion thereof in the tooth trace direction.

### BACKGROUND OF THE INVENTION

1. Field of the Invention

The present invention relates to a bevel gear to be used in a differential gear or the like for transmitting a power of an automobile, for example.

2. Background Art

In a vehicle such as an automobile, there has conventionally been disposed a differential gear 121 shown in FIG. 6 that distributes a power transmitted from a driving shaft to both wheels (not shown) through right and left axles 161 and 171. The differential gear 121 includes a differential case 141 rotatably supported by a transmission case 122 of a transmission 110, and a bevel gear 111 (a pair of side gears 111a and 111a, and a pair of pinion gears 111b and 111b) arranged in the differential case 141 such that axial centers X and Y of the bevel gear 111 are perpendicular to each other. The pinion gears 111b and 111b are mounted on a pinion shaft 157 positioned in the differential case 141. The side gears 111a and 111a are mounted on external splines 162 and 172 of the right and left axles 161 and 171 which are arranged such that axial centers thereof correspond to a rotation axis of the differential case 141.

An operation of the differential gear 121 is stated below. A driving force of an engine (not shown) is transmitted to a driving shaft 131, and is input to a ring gear 143 integrally fabricated with the differential case 141, so that the differential case 141 rotates about its rotation axis. While a rotational speed difference between both the axles 161 and 171 is adjusted, both the axles 161 and 171 can be rotated by the driving force in a balanced manner through the pinion gears 111b and 111b, and the side gears 111a and 111a.

Taking one of the side gears 111a as an example, a constitution of the bevel gear 111 which transmits a driving force is described below, with reference to the FIGS. 7A and 7B. The side gear 111a has a plurality of teeth 112a formed on an outside periphery thereof. A generating line P of a standard pitch cone of each of the teeth 112a inclines with respect to the axial center X. Thus, each of the teeth 112a has a larger diameter-side end surface 115 whose tooth depth is larger, on the side of a larger diameter of the standard pitch cone. On the other hand, each of the teeth 112a has a smaller diameter-side end surface 114 whose tooth depth is smaller, on the side of a smaller diameter of the standard pitch cone. Each of both tooth flanks 113a and 113a of each of the plurality of teeth 112a generally forms an elliptic crowning way with its longer sides being formed of an elliptically arc shape, with each of central portions 120 and 120 being bulged in a tooth trace direction. Similarly in each of the pinion gears 111b, a generating line of a standard pitch cone inclines with respect to the axial center Y, so that each of both tooth flanks 113b and 113b of each of teeth 112b forms an elliptic crowning way with its longer sides being formed of an elliptically arc shape, although the shape of the crowning way may be somewhat different from that of each of the teeth 112a.

As shown in FIG. 6, the side gears 111a and the pinion gears 111b are fabricated such that their axial centers X and Y are perpendicular to each other, so as to form the differential gear 121. By an engagement of the teeth 112a of the side gears 111a and the teeth 112b of the pinion gears 111b, the side gears 111a and the pinion gears 111b can transmit a driving force. The teeth 112a and 112b are engaged as described below. When the side gears 111a and the pinion gears 111b are disposed in position, top areas of the tooth flanks 113a and 113b each forming the crowning way come into contact with each other. Since the contacting portion is subjected to a driving force (load), a position of the contacting portion is designed to be the top areas of the tooth flanks 113a and 113b, the top areas having an excellent strength.

Since the side gears 111a and the pinion gears 111b are disposed in position by an engagement of the teeth 112a and 112b of the respective gears 111a and 111b in the differential case 141, an assembly error of the side gears 111a and the pinion gears 111b is prone to occur. As shown in FIG. 8, it may be possible that the axial center X of the side gear 111a and the axial center Y of the pinion gear 111b are positioned in a slightly inclined manner (not perpendicular to each other), because of an assembly error and/or a process error. In this state, a gap between the tooth flanks 113a and 113b which are opposed near the central portions 120 is relatively small. This is because the central portion 120 in the tooth trace direction of each of the tooth flanks 113a and 113b forming an elliptical crowning way with its longer sides being formed of an elliptically arc shape is smoothened (with a smaller curvature) as compared with ends of the tooth flanks 113a and 113b. Accordingly, because of the slight inclination of the axial center Y, the tooth flanks 113a and 113b are engaged in contact with each other at a position considerably far (distance S2) from a predetermined contacting portion K in the tooth trace direction.

A predetermined strength and endurance of the teeth 112 of the bevel gear 111 can be anticipated when the tooth flanks 113a and 113b are engaged in contact with each other at the predetermined contacting portion K which is previously designed. Thus, when an actual contacting portion K2 where the tooth flanks 113a and 113b are actually engaged in contact with each other is considerably far from the predetermined contacting portion K, the teeth 112 are engaged in contact with each other at a portion of lower strength. As a result, the endurance of the teeth 112 may be deteriorated.

### SUMMARY OF THE INVENTION

An object of the present invention is to bring an actual contacting portion of an engagement of a bevel gear close to a predetermined contacting portion which is previously designed, only by changing a form of a tooth flank, with a basic structure of the bevel gear being maintained.

The present invention is a bevel gear having a plurality of teeth on an outside periphery thereof, each of both tooth flanks of each of the plurality of teeth forming a crowning way with a bulge in a tooth trace direction, a generating line of a standard pitch cone of each of the plurality of teeth inclining with respect to an axial center, wherein each of the both tooth flanks of each of the plurality of teeth is formed into an arc shape, at least at a central portion thereof in the tooth trace direction.

In the bevel gear according to the present invention, each of the tooth flanks is formed into an arc shape at the central portion in the tooth trace direction, so that a gap between the opposed teeth can be gradually enlarged from a predetermined contacting portion of the tooth flanks of the teeth to be engaged toward ends thereof. Thus, even when an axial center of the bevel gear to be engaged is inclined because of a permissible assembly error and/or a process error, a position of an actual contacting portion can come near the predetermined contacting portion. Consequently, a deterioration of a strength and an endurance of the teeth can be advantageously prevented.

For example, each of the both tooth flanks of each of the plurality of teeth may be formed into an arc shape in whole. Alternatively, each of the both tooth flanks of each of the plurality of teeth may be formed into an arc shape, only at a central portion thereof in the tooth trace direction.

### BRIEF DESCRIPTION OF THE DRAWINGS

FIG. 1 is a partial cross-sectional front view showing a differential gear including a bevel gear in an embodiment of the present invention;

FIG. 2A is a cross-sectional front view of the bevel gear in the embodiment of the present invention;

FIG. 2B is a cross-sectional view of a tooth of the bevel gear shown in FIG. 2A taken along a standard pitch cone;

FIG. 3 is an illustrational view showing an engagement of the bevel gear with two axial centers thereof being perpendicular to each other, wherein the solid line indicating an engagement of the bevel gear in the embodiment, while the two-dot chain line indicating an engagement of a conventional bevel gear;

FIG. 4 is an illustrational view showing an engagement of the bevel gear of the embodiment, with two axial centers thereof being slightly inclined;

FIG. 5A is a cross-sectional front view of a bevel gear of another embodiment of the present invention;

FIG. 5B is a cross-sectional view of a tooth of the bevel gear shown in FIG. 5A taken along a standard pitch cone;

FIG. 6 is a partial cross-sectional front view showing a differential gear including a conventional bevel gear;

FIG. 7A is a cross-sectional front view of the conventional bevel gear;

FIG. 7B is a cross-sectional view of a tooth of the bevel gear shown in FIG. 7A taken along a standard pitch cone; and

FIG. 8 is an illustrational view showing an engagement of the conventional bevel gear, with two axial centers thereof being slightly inclined.

### DETAILED DESCRIPTION OF THE INVENTION

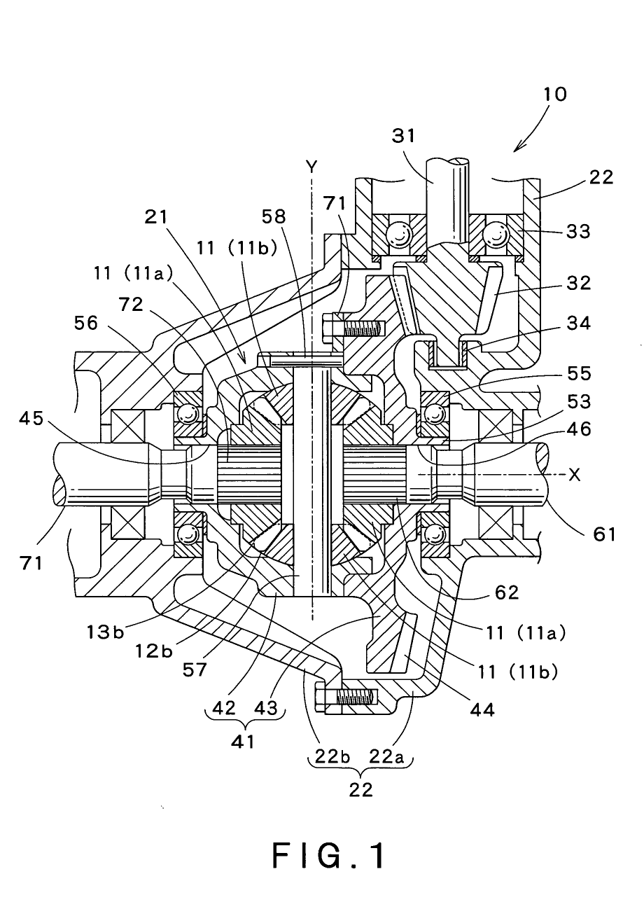

An embodiment of a bevel gear according to the present invention is described in detail below, with reference to FIGS. 1 to 5.

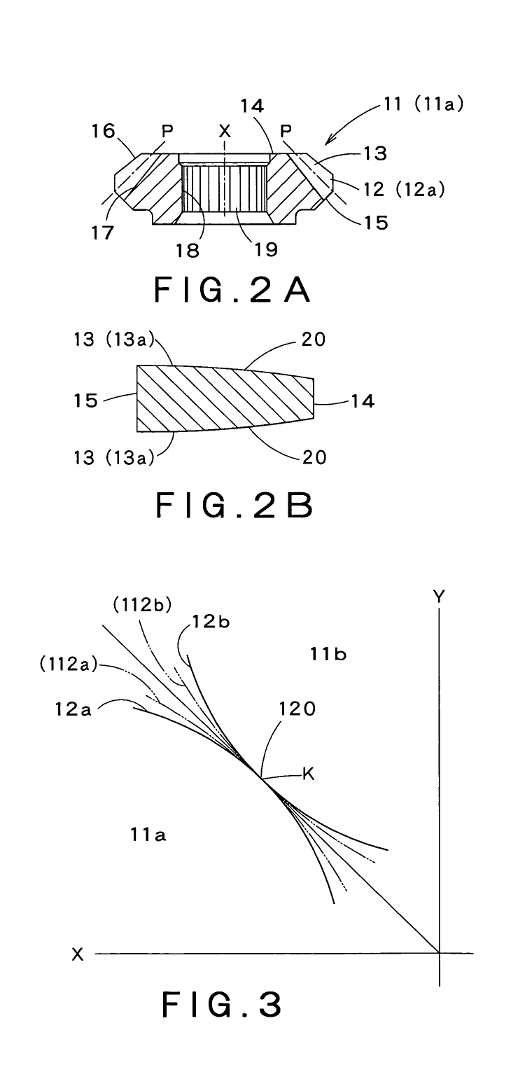

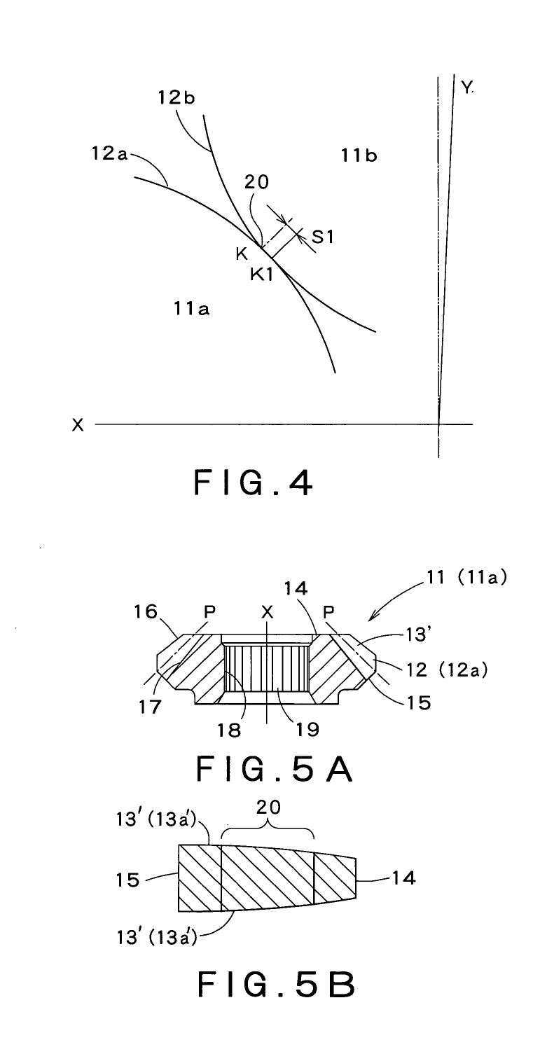

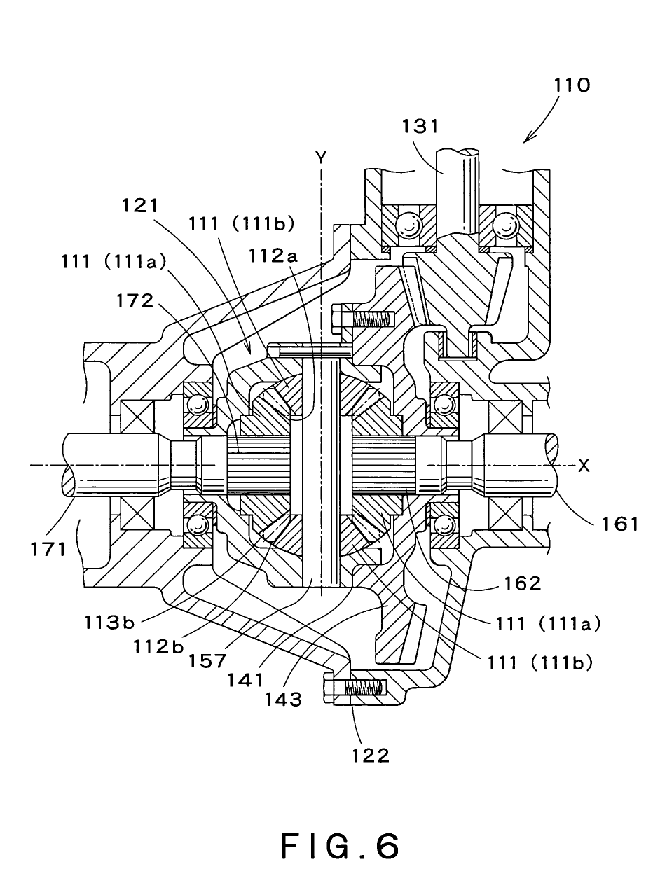

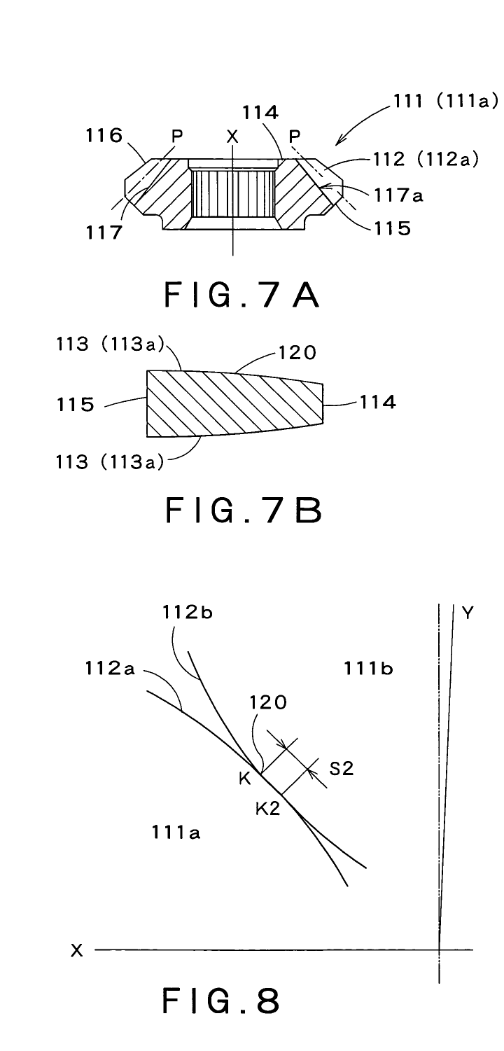

FIG. 1 is a partial cross-sectional front view showing a differential gear including a bevel gear in an embodiment of the present invention. FIG. 2A is a cross-sectional front view of the bevel gear in the embodiment of the present invention. FIG. 2B is a cross-sectional view of a tooth of the bevel gear shown in FIG. 2A taken along a standard pitch cone. FIG. 3 is an illustrational view showing an engagement of the bevel gear with two axial centers thereof being perpendicular to each other, wherein the solid line indicating an engagement of the bevel gear in the embodiment, while the two-dot chain line indicating an engagement of a conventional bevel gear. FIG. 4 is an illustrational view showing an engagement of the bevel gear of the embodiment, with two axial centers thereof being slightly inclined. FIG. 5A is a cross-sectional front view of a bevel gear of another embodiment of the present invention. FIG. 5B is a cross-sectional view of a tooth of the bevel gear shown in FIG. 5A taken along a standard pitch cone.

As shown in FIG. 1, a bevel gear 11 in the embodiment is installed in a differential gear 21. The bevel gear 11 is formed of side gears 11a and pinion gears 11b. The differential gear 21 is rotatably supported in a transmission case 22 through ball bearings 55 and 56.

The differential gear 21 includes a case semi-body 42 of a half shell shape having a case opening 45 at a center thereof, and a ring gear 43 of a disk shape having. a ring opening 46 at a center thereof. The case semi-body 42 and the ring gear 43 are integrally fabricated by means of bolts 71 to form a differential case 41. A diameter of the ring opening 46 is the same as that of the case opening 45. A beveled ring tooth 44 is disposed on an outside peripheral surface of the ring gear 43.

Axles 71 and 61 project respectively from the case opening 45 and the ring opening 46 of the differential case 41 in opposite directions. The side gears 11a and 11a are respectively mounted on splines 72 and 62 of the axles 71 and 61 disposed in the differential case 41. A pinion shaft 57 is positioned between the axles 71 and 61 such that the pinion shaft 57 is perpendicular to axial centers of the axles 71 and 61. The pinion gears 11b, each of which is engaged with a tooth 12 of each of the side gears 11a, are mounted on the pinion shaft 57.

The ring tooth 44 of the ring gear 43 constituting the differential case 41 is engaged with a driving gear 32 of a driving shaft 31 which is positioned so as to be perpendicular to the axial centers of the axles 61 and 71. The driving shaft 31 is rotatably supported in the transmission case 22 through a ball bearing 33 and a needle bearing 34.

An operation of the differential gear 21 is stated below. A driving force of an engine (not shown) is transmitted to the ring gear 43 constituting the differential case 41 through the driving shaft 31, so that the differential case 41 rotates about its rotation axis. While a rotational speed difference between both the axles 61 and 71 is adjusted, both the axles 61 and 71 can be rotated by the driving force in a balanced manner through the pinion gears 11b and 11b and the side gears 11a and 11a.

Taking one of the side gears 11a as an example, a constitution of the bevel gear 11 which transmits a driving force is described below, with reference to FIGS. 2A and 2B. As shown in FIG. 2A, the side gear 11a has a through-hole 18 which is in parallel with an axial center X. An internal spline 19 is formed on an inside periphery of the through-hole 18. The internal spline 19 is engaged with one of the external splines 62 and 72 of the axles 61 and 71. The side gear 11a has a plurality of teeth 12a formed on an outside periphery thereof. A generating line P of a standard pitch cone of each of the teeth 12a inclines with respect to the axial center X. Thus, each of the teeth 12a has a larger diameter-side end surface 15 whose tooth depth is larger, on the side of a larger diameter of the standard pitch cone. On the other hand, each of the teeth 12a has a smaller diameter-side end surface 14 whose tooth depth is smaller, on the side of a smaller diameter of the standard pitch cone. Each of both tooth flanks 13a and 13a of each of the plurality of teeth 12a forms an arcuate (not elliptic) crowning way, which is a characteristic feature of the present invention, with each of central portions 20 and 20 being bulged in a tooth trace direction. Similarly in each of the pinion gears 11b, a generating line of a standard pitch cone inclines with respect to the axial center Y, so that each of both tooth flanks 13b and 13b of each of teeth 12b forms an arcuate crowning way, although the shape of the crowning way may be somewhat different from that of each of the teeth 12a.

As shown in FIG. 1, the side gears 11a and the pinion gears 11b are fabricated such that their axial centers X and Y are perpendicular to each other, so as to form the differential gear 21. By an engagement of the teeth 12a of the side gears 11a and the teeth 12b of the pinion gears 11b, the side gears 11a and the pinion gears 11b can transmit a driving force. Referring to FIG. 3, the engagement of the teeth 12a and 12b is explained below. When the side gears 11a and pinion gears 11b are disposed in position, top areas of the tooth flanks 13a and 13b (indicated by the solid line) each forming the crowning way come into contact with each other. Since a contacting portion K is subjected to a driving force (load), a position of the contacting portion K is designed to be the top areas of the tooth flanks 13a and 13b, the top areas having an excellent strength. Near the central portions 20 where the tooth flanks 13a and 13b are in contact with each other, a relatively larger gap is formed between the opposed tooth flanks 13a and 13b toward ends thereof, as compared with a gap between conventional tooth flanks (indicated by the two-dot chain line) each having an elliptic shape with its longer sides being formed of an elliptically arc shape.

Since the side gears 11a and the pinion gears 11b are disposed in position by the engagement of the teeth 12a of the side gears 11a and the teeth 12b of the pinion gears 11b in the differential case 41, an assembly error of the side gears 11a and the pinion gears 11b is prone to occur. As shown in FIG. 4, it may be possible that the axial center X of the side gear 11a and the axial center Y of the pinion gear 11b are positioned in a slightly inclined manner (not perpendicular to each other), because of an assembly error and/or a process error. In this state, near the central portions 20 where the tooth flanks 13a and 13b each forming the arcuate crowning way are in contact with each other, a relatively larger gap is formed between the opposed tooth flanks 13a and 13b toward the ends thereof, as compared with a gap between conventional tooth flanks each having an elliptic shape with its longer sides being formed of an elliptically arc shape. Thus, even when the axial center Y is slightly inclined, an actual contacting portion K1 where the tooth flanks 13a and 13b are engaged in contact with each other can be prevented from being considerably drawing away from a predetermined contacting portion K which has been previously designed (deviation is only a distance S1). That is, the actual contacting portion K1 can be brought closer to the predetermined contacting portion K.

The preferred embodiment of the present invention has been described as above. However, not limited thereto, various modifications and changes can be made, without departing from the scope of the present invention. In the above embodiment, each of the tooth flanks 13a and 13b of the bevel gear 11 is formed into an arc shape in whole. However, as shown in FIGS. 5A and 5B for example, each of the tooth flanks 13a and 13b may be formed into an arc shape only at a central portion 20 thereof in the tooth trace direction. In this case, each of rest parts of the tooth flanks extending continuously from the central portions 20 to the respective ends 14 and 15 may be formed into any shape.

1. A bevel gear having a plurality of teeth on an outside periphery thereof, each of both tooth flanks of each of the plurality of teeth forming a crowning way with a bulge in a tooth trace direction, a generating line of a standard pitch cone of each of the plurality of teeth inclining with respect to an axial center, wherein
each of the both tooth flanks of each of the plurality of teeth is formed into an arc shape, at least at a central portion thereof in the tooth trace direction.

2. A bevel gear according to claim 1, wherein
each of the both tooth flanks of each of the plurality of teeth is formed into an arc shape in whole.

3. A bevel gear according to claim 1, wherein
each of the both tooth flanks of each of the plurality of teeth is formed into an arc shape, only at a central portion thereof in the tooth trace direction.
